(19) United States
(12) Patent Application Publication
(10) Pub. No.: US 2022/0151753 A1
(43) Pub. Date: May 19, 2022

(54) Personal Care Device

(71) Applicant: Colgate-Palmolive Company, New York, NY (US)

(72) Inventors: Jiang ZHOU, Yangzhou (CN); Yanmei JI, Jiangsu (CN); Tonny HE, Yangzhou (CN)

(73) Assignee: Colgate-Palmolive Company, New York, NY (US)

(21) Appl. No.: 17/098,701

(22) Filed: Nov. 16, 2020

(51) Int. Cl. A61C 17/02

(52) U.S. Cl. CPC A61C 17/0202

(57) ABSTRACT

A personal care device, such as an irrigator, which may be an oral irrigator, a nasal irrigator, or similar. The personal care device may be used to cleanse a user's oral cavity, such as by injecting a liquid such as water into the spaces between a user's teeth. The device may include two housings that are slidably coupled together, with the upper housing containing the electronic components and the lower housing containing a reservoir for holding water or other liquids that are to be dispensed. During use, the lower housing may slide upwardly as the liquid is dispensed due to the formation of a vacuum inside of the cavity of the lower housing. Thus, an air flow passageway may be formed that extends from the ambient into the cavity of the lower housing. The device may also include a cap with a locking closure to prevent accidental opening and spilling.

### BACKGROUND

Personal care devices, including irrigators such as oral irrigators for tooth flossing, are fairly common among households. Some such oral irrigators including two distinct housings that are slidably coupled together, whereby the upper housing contains the electronic components and the lower housing holds the water that is used during the irrigation process. However, it has been found that with oral irrigators of this type, the lower housing may slide upwardly during use as the water is being dispensed, which can pinch a user's skin. Moreover, in personal care devices which include reservoirs that hold a liquid such as water, there is a continuing need to improve the seal performed by any cap that is used to close such reservoir. Thus, a need exists for solutions to these problems.

### BRIEF SUMMARY

The present invention is directed to a personal care device, such as an irrigator, which may be an oral irrigator, a nasal irrigator, or similar. The personal care device may be used to cleanse a user's oral cavity, such as by injecting a liquid such as water into the spaces between a user's teeth. The device may include two housings that are slidably coupled together, with the upper housing containing the electronic components and the lower housing containing a reservoir for holding water or other liquids that are to be dispensed. During use, the lower housing may slide upwardly as the liquid is dispensed due to the formation of a vacuum inside of the cavity of the lower housing. Thus, an air flow passageway may be formed that extends from the ambient into the cavity of the lower housing. The device may also include a cap with a locking closure to prevent accidental opening and spilling.

In one aspect, the invention may be a personal care device comprising: an upper housing comprising a top end, an outer surface, and a first cavity; a motor and a pump operably coupled together and located within the first cavity of the upper housing; a lower housing comprising a second cavity having an open top end, an opening through which liquid can be introduced into the second cavity, and a cap alterable between a closed state whereby the cap closes the opening and an open state whereby the opening forms a passageway from an ambient environment into the second cavity, wherein at least a portion of the upper housing nests within the second cavity of the lower housing and the lower housing is slidably coupled to the upper housing between a compressed position and an expanded position; an air flow passageway extending from the outer surface of the upper housing to the second cavity of the lower housing; and wherein upon introducing a liquid into the second cavity through the opening and actuating the motor, the pump is configured to pump the liquid from the second cavity through an outlet in the top end of the upper housing, and wherein as the liquid is pumped from the second cavity air from the ambient environment is introduced into the second cavity through the air flow passageway.

In another aspect, the invention may be a personal care device comprising: an upper housing comprising a sidewall and a floor that define a first cavity; a nozzle coupled to the upper housing; a motor and a pump operably coupled together and located within the first cavity of the upper housing; a lower housing slidably coupled to the upper housing between a compressed position and an expanded position, the lower housing comprising a second cavity having a volume that increases as the lower housing is moved from the compressed position to the expanded position, the second cavity configured to hold a liquid that is injected by the nozzle upon actuation of the motor; and an air flow passageway extending from an inlet opening in the sidewall of the upper housing to an outlet opening in the floor of the upper housing, the air flow passageway configured to introduce air from an ambient environment into the second cavity of the lower housing as the liquid in the second cavity of the lower housing is pumped from the second cavity to the nozzle.

In yet another aspect, the invention may be a personal care device comprising: an upper housing comprising a first cavity; a motor and a pump positioned in the first cavity and operably coupled together; a lower housing comprising a second cavity configured to hold a liquid, wherein the lower housing is slidably coupled to the upper housing with a portion of the upper housing positioned within the second cavity; and an air flow passageway configured to introduce air from an ambient environment into the second cavity of the lower housing as the liquid in the second cavity of the lower housing is pumped from the second cavity through an outlet in the upper housing.

In still another aspect, the invention may be personal care device comprising: a housing comprising an inner surface that defines a cavity and an opening through which liquid can be introduced into the cavity; and a cap alterable between a closed state whereby the cap closes the opening and an open state whereby the opening is exposed, the cap comprising: a body portion having an inner surface; an annular sidewall extending from the inner surface of the body portion to a distal end; and a plurality of locking tabs protruding obliquely from the distal end of the annular sidewall in a spaced apart manner, each of the locking tabs comprising a locking surface that faces the body portion; and wherein when the cap is in the closed state, the inner surface of the body portion closes the opening of the housing and the locking surfaces of the locking tabs engage the inner surface of the housing to retain the cap in the closed state.

In a further aspect, the invention may be a personal care device comprising: a housing comprising an inner surface that defines a cavity, an outer surface opposite the inner surface, and an upstanding annular wall extending from the outer surface to a distal end, an inner surface of the upstanding annular wall defining a passageway through which liquid can be introduced into the cavity, the passageway having a first width at the distal end of the upstanding annular wall and a second width at an intersection between the passageway and the cavity, the first width being greater than the second width; and a cap comprising: a longitudinal axis; a body portion having an inner surface; an annular sidewall extending from the inner surface of the body portion to a distal end; and a plurality of locking tabs protruding from the distal end of the annular sidewall to a distal end of the locking tabs, the cap having a third width measured along the distal ends of the locking tabs, the third width being less than the first width and greater than the second width; and wherein when altering the cap from an open state to a closed state to close the passageway, the distal ends of the locking tabs fit through the first opening of the passageway without any interference between the upstanding annular sidewall and the locking tabs, the inner surface of the upstanding annular wall between the first and second openings contacts the locking tabs and forces the locking tabs to flex inwardly towards the longitudinal axis, and the locking tabs flex outwardly upon exiting the passageway and entering the cavity to lock the cap in the closed state.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front perspective view of a personal care device in accordance with an embodiment of the present invention, wherein the personal care device is in a compressed state;

FIG. 2 is a rear perspective view of the personal care device of FIG. 1;

FIG. 3 is a side view of the personal care device of FIG. 1;

FIG. 4 is a cross-sectional taken along line IV-IV of FIG. 1;

FIG. 5 is a perspective view of the personal care device of FIG. 1 in an expanded state;

FIG. 6 is a cross-sectional view taken along line VI of FIG. 5;

FIG. 7 is a cross-sectional taken along line VII-VII of FIG. 5;

FIG. 8 is a close-up view of area VIII of FIG. 4;

FIG. 9 is a perspective view illustrating a user altering the personal care device of FIG. 1 from the compressed state to the expanded state;

FIG. 10 is a perspective view of the personal care device of FIG. 1 illustrating a user filling a cavity of a lower housing thereof with water;

FIG. 11 is a perspective view of the personal care device of FIG. 1, in the expanded state, illustrating the personal care device dispensing the water therefrom;

FIG. 12A is a cross-sectional view taken along line XIIA-XIIA of FIG. 11;

FIG. 12B is a cross-sectional view taken along line XIIB-XIIB of FIG. 11;

FIG. 13 is a close-up view of area XIII of FIG. 12;

FIG. 14 is a close-up view of a bottom portion of the personal care device of FIG. 1 illustrating a cap in an open state;

FIG. 15 is a cross-sectional view taken along line XV-XV of FIG. 14; and

FIGS. 16 and 17 are the cross-sectional view of FIG. 15, illustrating the process of altering the cap from the open state to a closed state.

### DETAILED DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

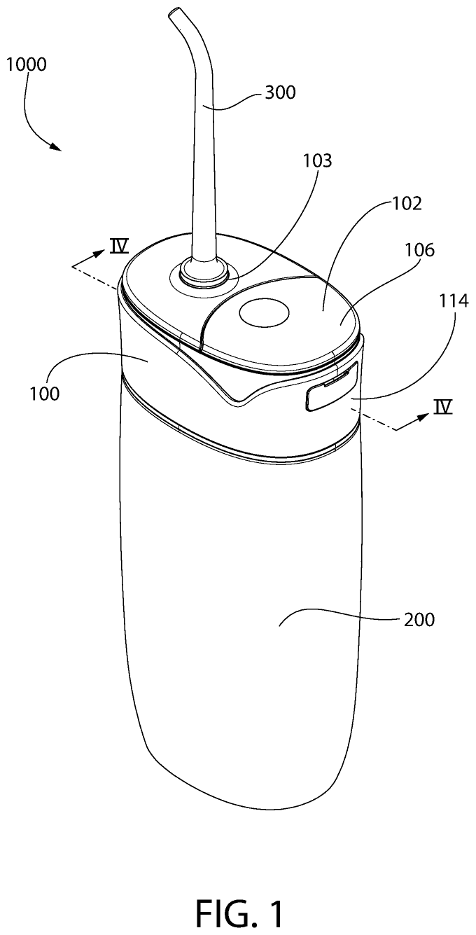

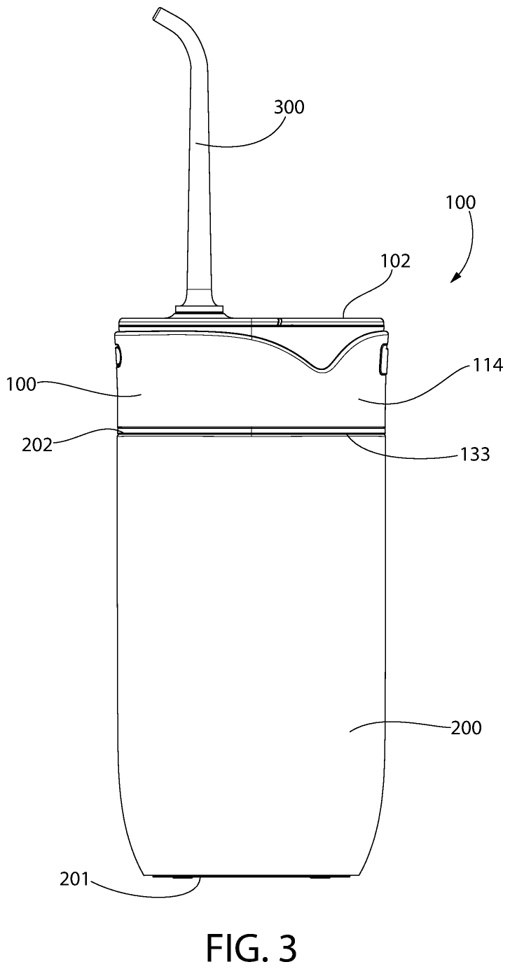

Referring first to FIGS. 1-7, a personal care device 1000 is illustrated in accordance with an embodiment of the present invention. In the exemplified embodiment, the personal care device 1000 is an irrigation device, such as an oral irrigator, a nasal irrigator, or the like, which is intended to provide treatment to a user by injecting a liquid such as water onto or into the user. However, the personal care device 1000 is not limited to being an irrigation device in all embodiments, and in other embodiments the personal care device 1000 may be any type of personal care device which is designed to hold a liquid such as water, mouthwash, whitening solution, or the like, and to dispense that liquid onto a user's body, into a user's nasal cavity, into a user's oral cavity, or the like. Thus, for example, the personal care device 1000 may be a toothbrush that includes a liquid dispensing system, a skin application device that can dispense a liquid onto a user's skin, or any other type of device that can hold a liquid for injection for purposes of providing treatment to a user. In the exemplified and preferred embodiment, the personal care device is an oral irrigator.

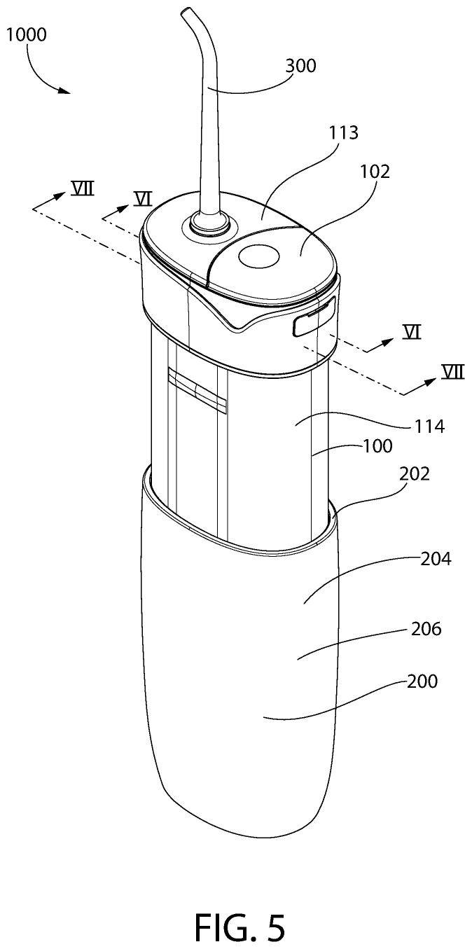

The personal care device 1000 comprises an upper housing 100 and a lower housing 200 that are slidably coupled together. In particular, the upper housing 100 and the lower housing 200 are slidably coupled together between a compressed state, a shown in FIGS. 1-4, and an expanded state, as shown in FIGS. 5-7. The lower housing 200 slides relative to the upper housing 100 around an outside of the upper housing 100 between the compressed and expanded states, with the lower and upper housings 200, 100 remaining coupled together in the compressed and expanded states and all states or positions in between. That is, a portion of the upper housing 100 is positioned within an interior of the lower housing 200 at all times. While the personal care device 100 is described here as having compressed and expanded states, in some embodiments the lower housing 200 may be in a compressed position when the personal care device 100 is in the compressed state and the lower housing 200 may be in an expanded position when the personal care device 100 is in the expanded state.

A user can alter the upper and lower housings 100, 200 between the compressed and expanded states by pulling one of the upper and lower housings 100, 200 axially relative to the other of the upper and lower housings 100, 200. The upper and lower housings 100, 200 remain coupled together in both of the compressed and expanded states. As the upper and lower housings 100, 200 transition from the expanded state to the compressed state, a larger percentage of the upper housing 100 enters into and nests within a cavity of the lower housing 200, thereby changing the available volume of the cavity of the lower housing 200 for containing a liquid, as discussed further below.

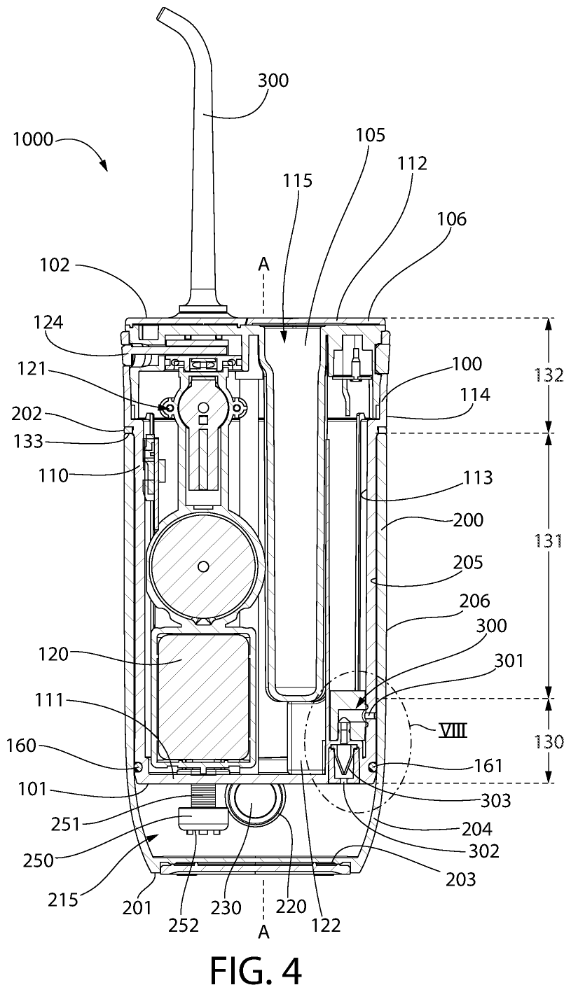

The upper housing 100 extends from a bottom end 101 to a top end 102 along a longitudinal axis A-A. The upper housing 100 comprises an outlet 103 through which liquid can be injected during use. A nozzle 300 may be coupled to the upper housing 100 at the outlet 103 so that liquid injected from the outlet 103 passes through the nozzle 300 prior to reaching its final destination (i.e., a user's oral cavity, nasal cavity, or the like). The nozzle 300 may be detachable from the upper housing 100 and may be stored in a storage compartment 105 (FIG. 4) when not in use. In particular, the upper housing 100 may comprise a lid 106 that is configured to be opened to expose the storage compartment 105 for purposes of inserting the nozzle 300 into and removing the nozzle 300 from the storage compartment 105.

The upper housing 100 comprises a sidewall 110, a floor 111, and a roof 112 that collectively form an enclosure of the upper housing 100. In the exemplified embodiment, the lid 106 forms a part of the roof 112, and the lid 106 is pivotable relative to a remainder of the roof 112 to open and close the lid 106. The lid 106 may be attached to the remainder of the roof 112 via a hinge, such as a living hinge, in some embodiments. The sidewall 110, the floor 111, and the roof 112 collectively define a first cavity 115 of the upper housing 100, which is configured to hold various electronic components of the personal care device 100 that are necessary for operation thereof. Specifically, the sidewall 110 comprises an inner surface 113 and an outer surface 114 opposite the inner surface 113. The inner and outer surfaces 113, 114 of the sidewall 110 form the inner and outer surfaces of the upper housing 100. The inner surface 113 of the sidewall 110 surrounds the first cavity 115.

In particular, in the exemplified embodiment there is a motor 120, a pump 121, and a power source 122 positioned within the first cavity 115 of the upper housing 100. The motor 120, the pump 121, and the power source 122 are operably coupled together so that upon power from the power source 122 being supplied to the motor 120, the motor 120 is activated and causes the pump 121 to pump liquid from the second housing 200 to the nozzle 300 as described in greater detail herein below. In some embodiments, the power source 122 may be omitted and the personal care device 1000 may include a power cord for plugging into a wall socket for purposes of supplying power to the motor 120. Thus, the power source 122 need not form a part of the personal care device 1000 in all embodiments. In embodiments that include the power source 122, the power source 122 may comprise one or more batteries of any type required to provide sufficient power to power the motor 120 and the pump 121 and any other electronic components that may be included as a part of the personal care device 1000 (such as lights, speakers, or the like).

The pump 121 is not limited to being any particular type of pump. For example, the pump 121 may be a piston pump. In one embodiment, the piston pump may be a linear actuator piston pump. However, the invention is not to be so limited and the pump 121 can take on other forms, such as being a positive displacement pump, a rotary pump, a reciprocating pump, a gear pump, a screw pump, a peristaltic pump, or any other type of pump now known or later discovered. The pump 121 may be one that uses the rotational motion of the motor 120 and converts it to linear motion for purposes of pumping the liquid, in some embodiments.

There is also a switch 124 located on the upper housing 100 for powering the motor 120 on and off. Specifically, the switch 124 is alterable between an off state whereby power is not supplied from the power source 12 to the motor 120 and an on state whereby power is supplied from the power source 122 to the motor 120 to actuate the motor 120. In the exemplified embodiment, the switch 124 is a push button switch that operates such that a single push of the switch 124 alters the motor 120 from an off state to an on state and a second push of the switch 124 alters the motor 120 from the on state to the off state. The invention is not limited to the switch 124 being a push button switch in all embodiments and the switch 124 can take on any of various different forms including being a slide switch, a toggle switch, a conductive switch, or the like. Moreover, the personal care device 1000 may be configured to operate in multiple different modes such that instead of just on/off, various actuations of the switch 124 will transition the personal care device 1000 through different modes of operation (including changing the speed of the motor 120 and also the velocity at which the liquid is injected, a pulse mode, a continuous mode, etc.).

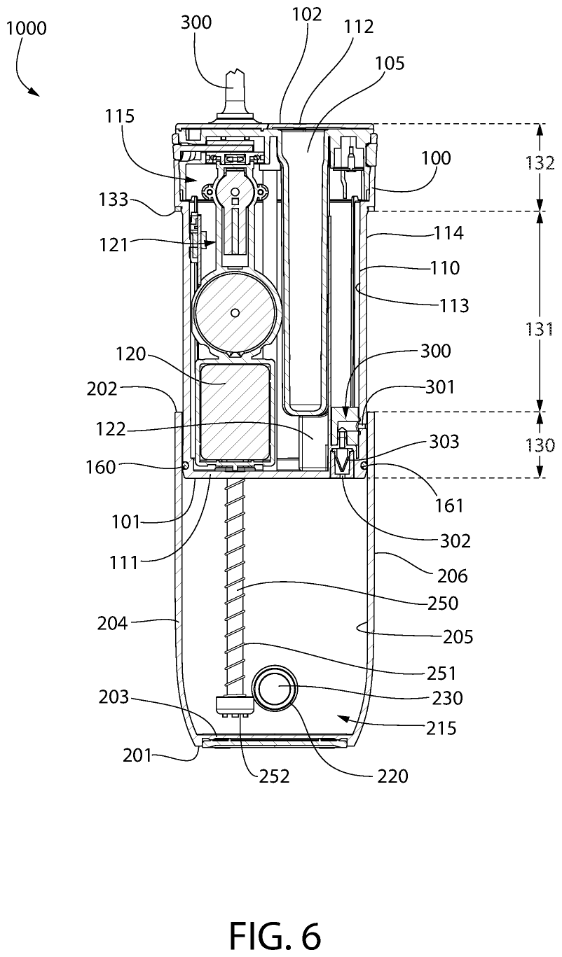

The upper housing 100 can be conceptually divided into multiple axial portions. Particularly, the upper housing 100 comprises a lower axial portion 130 which comprises the bottom end 101 of the upper housing 100, an upper axial portion 132 which comprises the top end 102 of the upper housing 100, and a middle axial portion 131 which extends between the lower and upper axial portions 130, 132. The lower housing 200 comprises a second cavity 215. The upper and lower housings 100, 200 are coupled together so that a portion of the upper housing 100 is always located within the cavity 215 of the lower housing 200. In particular, in the compressed state as shown in FIG. 4, the lower and middle axial portions 130, 131 of the upper housing 100 are located within the cavity 215 of the lower housing 200 and the upper axial portion 132 protrudes from a top end 202 of the lower housing 200. In the expanded state as shown in FIG. 6, the lower axial portion 130 is located within the cavity 215 of the lower housing 200 and the middle and upper axial portions 131, 132 protrude from the top end 202 of the lower housing 200.

The upper axial portion 132 of the upper housing 100 has a greater transverse dimension (i.e., width) than the lower and middle axial portions 130, 131. Thus, the upper housing 100 comprises a downwardly facing shoulder 133 at the junction between the middle and upper axial portions 131, 132. The downwardly facing shoulder 133 forms a stopper that prevents the upper axial portion 132 from being inserted into the second cavity 215 of the lower housing 200.

Turning to the lower housing 200, the lower housing 200 extends from a bottom end 201 to the top end 202 along an axis which is coextensive with the longitudinal axis A-A of the upper housing 100. The lower housing 200 comprises a floor 203 and a sidewall 204 that collectively define the second cavity 215 of the lower housing 200. The sidewall 204 has an inner surface 205 that faces the second cavity 215 and an outer surface 206 opposite the inner surface 205, with the outer surface 206 forming the outer surface of the lower housing 200. The second cavity 215 of the lower housing 200 has an open top end at the top end 202 of the lower housing 200. The open top end of the second cavity 215 is sufficiently large to enable the upper housing 100 to fit therein to facilitate the slidable coupling between the upper and lower housings 100, 200. As shown in FIG. 4, when the personal care device 1000 is in the compressed state, the downwardly facing shoulder 133 abuts against the top end 202 of the lower housing 100 to prevent the upper axial section 132 from entering into the second cavity 215. In this compressed state, the lower and middle axial portions 130, 131 of the upper housing 100 are disposed within the second cavity 215 of the lower housing 200.

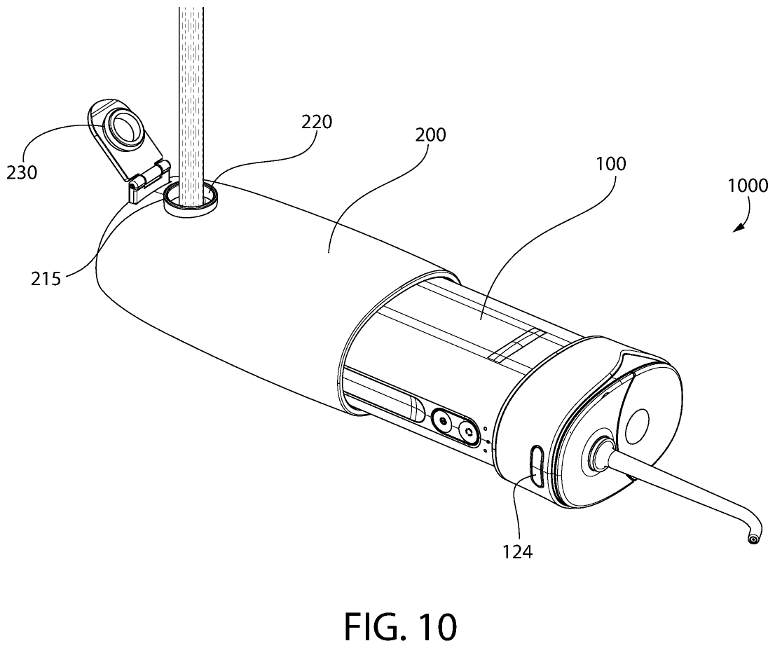

The second cavity 215 of the lower housing 200 is configured to hold a liquid, such as water, which is dispensed through the nozzle 300 during use of the personal care implement 1000. However, as noted above, the open top end of the second cavity 215 is always covered by the upper housing 100 since a portion of the upper housing 100 is always located within the second cavity 215. Thus, the liquid cannot be introduced into the second cavity 215 through the opening in the top end 202. In that regard, the lower housing 200 comprises an opening 220 that is generally used to fill the second cavity 215 of the second housing 200 with a liquid (i.e., water, mouthwash, or the like) prior to use. The opening 220 forms a passageway from the ambient environment into the second cavity 215 (see FIG. 10).

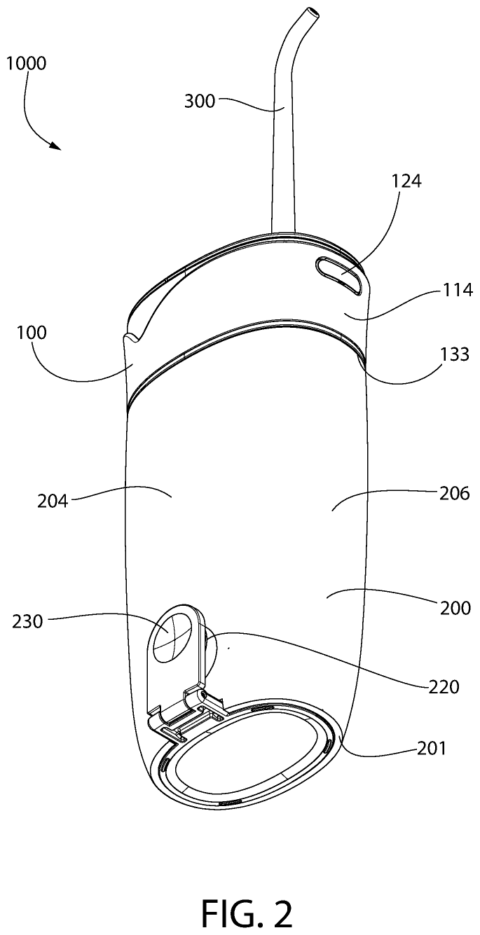

Furthermore, the second housing 200 comprises a cap 230 that is configured to close the opening 220 when liquid is not being introduced into the second cavity 215. That is, the cap 230 is alterable between an open state (shown in FIG. 10) whereby the opening 220 is exposed and there exists a passageway from the ambient environment into the second cavity 215 and a closed state (shown in FIG. 2, for example) whereby the cap 230 closes the opening 220. In the exemplified embodiment, the cap 230 is pivotably coupled to the second housing 200 so that the cap 230 is attached to the housing 200 in both of the open and closed states. Thus, even when the cap 230 is in the open state, it remains coupled to the housing 200 so that it will not get misplaced or lost. Of course, in other embodiments the cap 230 may be completely detached from the housing 200 when in the open state. The cap 230 is altered into the open state prior to a user introducing a liquid into the second cavity 215, and then the cap 230 is altered into the closed state so that the liquid does not leak out of the cavity 215 through the opening 220 prior to or during use.

The second cavity 215 is generally empty of components, other than the portion of the upper housing 100 that is nesting within the second cavity 215. As can be appreciated from a comparison of FIGS. 4 and 6, a volume of the second cavity 215 that is available for liquid is greater when the personal care device 1000 is in the expanded state than when it is in the compressed state. Typically, the personal care device 1000 is placed into the compressed state when not in use for storage because it takes up less space. The personal care device 1000 is then altered into the expanded state prior to use so that there is sufficient volume in the second cavity 215 to fill with the liquid that will be used during the hygiene irrigation operation. It may be possible to use the personal care device 1000 in the compressed state, although only a small amount of liquid will be available for use at a time in such state and thus typically the personal care device 1000 is expanded prior to filling with liquid and using.

Again reviewing FIGS. 4 and 6, a delivery member 250 is depicted which extends from the bottom end 101 of the upper housing 100 and into the second cavity 215 of the lower housing 200. The delivery member 250 is a conduit having an internal passageway through which the liquid in the second cavity 215 can flow towards the nozzle 300 during use. In the exemplified embodiment, the delivery member 250 is coupled to the upper housing 100 with a compression spring 251. Thus, when the personal care device 1000 is in the compressed state, the delivery member 250 is moved upwardly into the first cavity 115 of the upper housing 100. As the personal care device 1000 moves from the compressed state to the expanded state, the delivery member 250 also moves downwardly and extends further from the bottom end 101 of the upper housing 100 so that a distal end 252 of the delivery member 250 is located adjacent to the floor 203 of the lower housing 200. That is, as the floor 203 of the lower housing 200 moves further from the floor 112 of the upper housing 100, the distal end 252 of the delivery member 250 moves further from the bottom end 101 of the upper housing 100 so that the distal end 252 of the delivery member 250 remains adjacent to the floor 203 of the lower housing 200. Thus, during use the liquid is pumped into the distal end 252 of the delivery member 250 by the pump 121 and because the distal end 252 of the delivery member 250 is located adjacent to the floor 203 of the lower housing 200, a substantial entirety of the liquid can be pumped out of the second cavity 215 during use.

The delivery member 250 may be formed from various different materials, including plastics, metals, or the like. The delivery member 250 is preferably free of holes or openings except at the distal end 252 and at an end opposite the distal end 252. During use, the liquid is pumped from the second cavity 215 and through the delivery member 250, and then from the delivery member 250 through a passageway in the upper housing 100 which is isolated from the electronic components (i.e., the motor 120, the pump 121, and the power source 122) to the outlet 103.

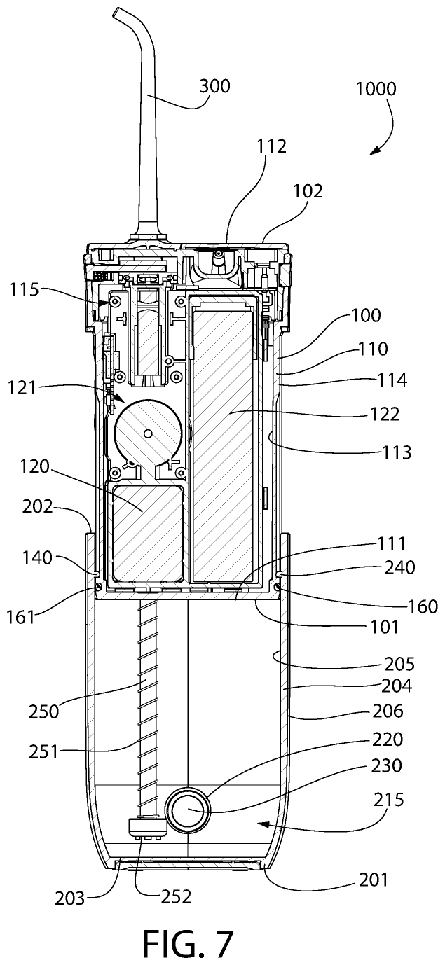

Referring briefly to FIG. 7, as noted above the upper and lower housings 100, 200 are retained in a coupled configuration in both the compressed and expanded states. In fact, the upper housing 100 is unable to be fully removed from the second cavity 215 of the lower housing 200. In particular, the upper housing 100 comprises an upwardly facing shoulder 140 near the bottom end 101 thereof. Furthermore, the lower housing 200 comprises a stopper protrusion 240 extending from the inner surface 204 of the sidewall 206 near the top end 202 of the lower housing 200. When the personal care device 1000 is in the fully expanded state as shown in FIG. 7, the upwardly facing shoulder 140 of the upper housing 100 abuts against the stopper protrusion 240 of the lower housing 100 to prevent the upper and lower housings 100, 200 from being pulled axially apart any further. The upwardly facing shoulder 140 and the stopper protrusion 240 are discrete components rather than being formed all the way around the upper and lower housings 100, 200 in the exemplified embodiment, although they could be formed annularly around the upper and lower housings 100, 200 in other embodiments.

Referring to FIGS. 4, 6, and 7, in the exemplified embodiment a seal member 160 is disposed around the outer surface 114 of the upper housing 100 adjacent to the bottom end 101 of the upper housing 100. Thus, the outer surface 114 of the upper housing 100 comprises an annular recess 161, and the seal member 160 is disposed within the annular recess 161. The seal member 160 may be formed from rubber or plastic and may be a gasket, an O-ring, or the like in various embodiments. The seal member 160 abuts against the outer surface 114 of the upper housing 100 and the inner surface 205 of the lower housing 200 to create a liquid-tight seal between the upper and lower housings 100, 200 to prevent the liquid in the second cavity 215 of the lower housing 200 from leaking in any gaps between the upper and lower housings 100, 200.

Referring to FIGS. 4, 6 and 8, the personal care device 1000 also comprises an air flow passageway 300. One issue with personal care devices of the type described herein is that during use of the product, as the liquid from the second cavity 215 is being injected out of the nozzle 300, a vacuum is formed inside of the second cavity 215. As a result of this vacuum, the lower housing 200 may slide upwardly relative to the upper housing 100 during use on its own without the user moving the lower housing 200. Because the user may be gripping the outer surface 114 of the upper housing 100 during use, if the lower housing 200 slides upwardly it may pinch the user's skin between the upper and lower housings 100, 200 causing discomfort. Thus, the purpose of the air flow passageway 300 is to introduce air into the second cavity 215 as the liquid is being pumped out of the second cavity 215 to avoid a vacuum being created in the second cavity 215. This makes it so that the lower housing 200 will not move on its own relative to the upper housing 100 during use.

In the exemplified embodiment, the air flow passageway 300 is formed into the upper housing 100. In other words, the upper housing 100 comprises the air flow passageway 300. The air flow passageway 300 can not be formed into the lower housing 200 because doing so would form a likely leak situation whereby liquid in the second cavity 215 would readily leak out of the second cavity 215 through the air flow passageway 300. Of course, it may be possible in other embodiments to form such an air flow passageway into the lower housing 200 without affecting the fluid tight nature of the second cavity 215. For example, the air flow passageway 300 coupled be formed into the lower housing 200 at a location that is above a maximum fluid level of any liquid in the second cavity 215. Alternatively, the air flow passageway 300 could be formed into the lower housing 200 at a location that is fluidly isolated from any portion of the second cavity 215 which is configured to hold the liquid.

In the exemplified embodiment, the air flow passageway 300 generally comprises an inlet opening 301 and an outlet opening 302. In the exemplified embodiment, the inlet opening 301 is formed through the sidewall 111 of the upper housing 100 and the outlet opening 302 is formed through the floor 112 of the upper housing 100. However, the invention is not to be so limited in all embodiments. For example, in one alternative embodiment, the inlet opening 301 may be formed in the sidewall 111 at a first distance from the bottom end 101 of the upper housing 100 and the outlet opening 302 may be formed in the sidewall 111 at a second distance from the bottom end 101 of the upper housing 100, the second distance being less than the first distance. In some embodiments, the inlet opening 301 may be formed in the sidewall 111 and the outlet opening 302 may be formed in one of: (1) the sidewall 111, at a location that is between the inlet opening 301 and the bottom end 101 of the upper housing 100; and (2) the floor 112 of the upper housing 100.

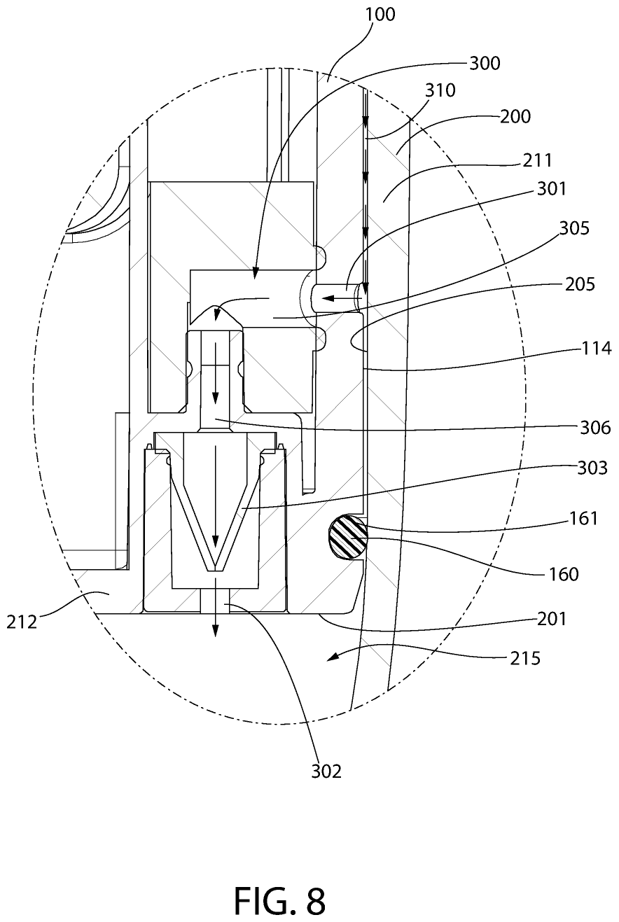

In any case, the air flow passageway 300 provides a passageway for air to be allowed to flow from the ambient environment into the second cavity 215. In particular, and as shown clearly in FIG. 8, air enters the air flow passageway 300 from ambient at the inlet opening 301 and exits the air flow passageway 300 to enter into the second cavity 215 at the outlet opening 302. Moreover, in the exemplified embodiment there is a check valve or a one-way valve 303 located in the air flow passageway 300. The one-way valve 303 is a duckbill valve in the exemplified embodiment, but the invention is not to be so limited in all embodiments. The one-way valve 303 could alternatively be a ball check valve, a diaphragm check valve, a swing check valve, a stop check valve, or the like in various alternative embodiments. The one-way valve 303 ensures that the air can flow in a first direction from the inlet opening 301 to the outlet opening 302, but not in a second direction opposite the first direction from the outlet opening 302 to the inlet opening 301.

In the exemplified embodiment, an entirety of the air flow passageway 300 is located within the lower axial portion 130 of the upper housing 100. Thus, the air flow passageway 300 is located along a portion of the upper housing 100 which is always disposed within the second cavity 215 of the lower housing 200 and always surrounded by the lower housing 200. This can be beneficial for several reasons. First, the inlet opening 301 is always covered by the sidewall 204 of the lower housing 200, which can prevent tiny particles and debris from clogging the inlet opening 301 or any part of the air flow passageway 300. Furthermore, because the inlet opening 301 is always covered by the lower housing 200, a user will not accidently block air flow through the inlet opening 301 with his/her fingers during use. Specifically, when a user holds the personal care implement 1000 during use, there is no way for the user to directly cover the inlet opening 301.

Moreover, the fact that the lower housing 200 covers the inlet opening 301 does not interfere with the ability of the air to flow from ambient into the air flow passageway 300 through the inlet opening 301. This is because, as perhaps best shown in FIG. 8, there is a gap 310 present between the outer surface 114 of the upper housing 100 and the inner surface 205 of the lower housing 200. The gap 310 extends axially from at least as low as the inlet opening 301 to the top end 202 of the lower housing 200. Thus, air can enter into the gap 310 at the top end 202 and flow through the gap 310 and through the inlet opening 301 into the air flow passageway 300 as described herein and shown with the arrows in FIG. 8. In the exemplified embodiment, the air flow passageway 301 comprises a first portion 305 which comprises the inlet opening 301 and extends in a direction transverse to the longitudinal axis A-A of the upper housing 100 and a second portion 306 which comprises the outlet opening 302 and extends in a direction parallel to the longitudinal axis A-A of the upper housing 100. Of course, the shape of the air flow passageway 300 need not be “L” shaped in all embodiments and it could be arcuate, S-shaped, N-shaped, or various other shapes in different embodiments.

The seal member 160 is located between the inlet opening 301 and the bottom end 201 of the upper housing 200. Stated another way, the inlet opening 301 is always located between the seal member 160 and the top end 202 of the lower housing 200. This is important because it ensures that there is a fluid tight seal between the upper and lower housings 100, 200 without interfering with the flow of air into and through the air flow passageway 300. In particular, if the seal member 160 were located between the inlet opening 301 and the top end 202 of the lower housing 200, the seal member 160 would prevent air from reaching the inlet opening 301.

As mentioned above, although in the exemplified embodiment the air flow passageway 300 is formed entirely in the upper housing 100, the invention is not to be so limited in all embodiments. In some embodiments, there may be an inlet opening in the lower housing 200 at a location that is aligned with or above the inlet opening 301 in the upper housing 100 when the personal care device 1000 is in the expanded state. In such an embodiment, the air can flow through the inlet opening in the lower housing 200 and thein into the inlet opening 301 rather than flowing into the gap 310 at the top end 202 of the lower housing 200. Moreover, in some embodiments the region of the upper housing 100 that includes the air flow passageway 300 could form a part of the lower housing 200 rather than forming a part of the upper housing 100.

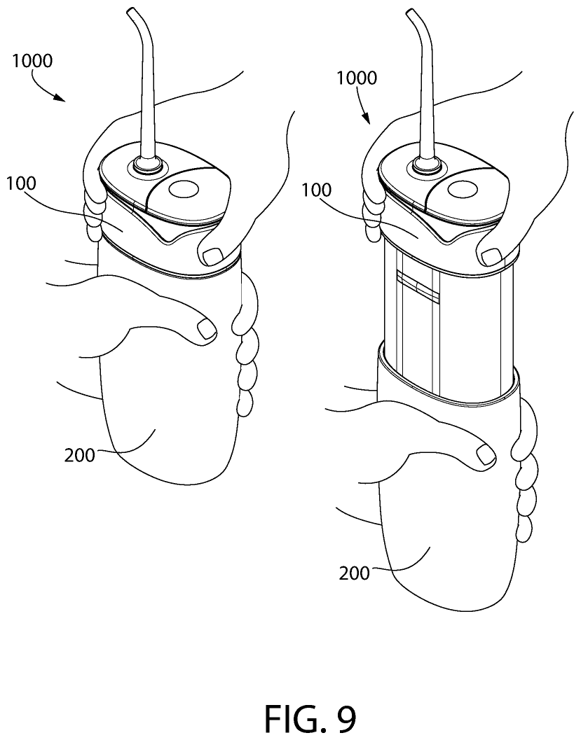

Referring to FIGS. 9-13 sequentially, use and operation of the personal care device 1000 will be described in accordance with an embodiment of the present invention. As shown in FIG. 9, the personal care device 1000 starts in the compressed state, as shown in the image on the left. Thus, the first step is for a user to pull the upper and lower housings 100, 200 apart from one another to alter the personal care device 100 from the compressed state to the expanded state. The personal care device 1000 is illustrated in the expanded state in the image on the right in FIG. 9.

Next, as shown in FIG. 10, the cap 230 covering the opening 220 in the lower housing 200 is altered from the closed state to the open state. After the cap 230 is moved to the open state, the opening 220 is exposed and a liquid such as water can be introduced into the second cavity 215 of the lower housing 200. For example, water can be poured into the second cavity 215 through the opening 220 from a faucet, from a container, from a cup, from a watering can, or the like. Once the second cavity 215 is filled with the liquid such as water to the desired level, the switch 124 can be actuated. In the exemplified embodiment, the switch 124 is a press button switch that is actuated by a user pressing the switch 124. As noted above, the switch 124 may take on other structural forms and may therefore be actuated in other ways in other embodiments.

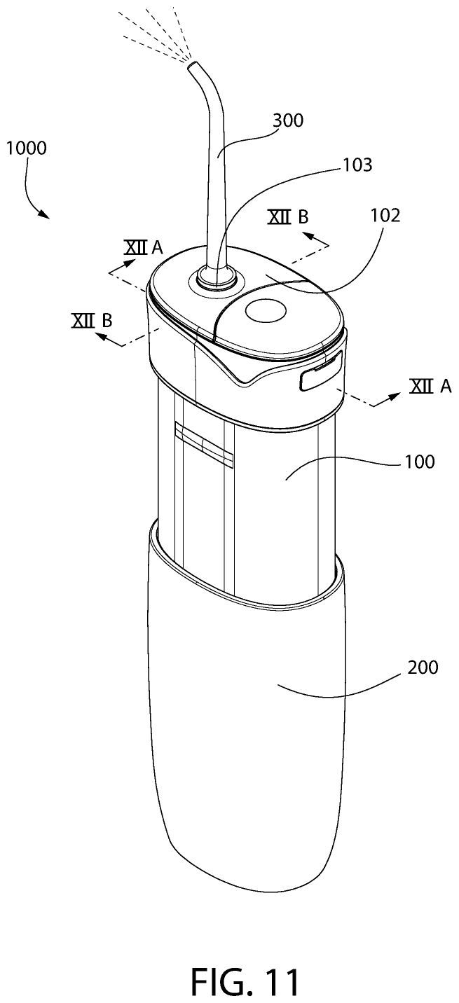

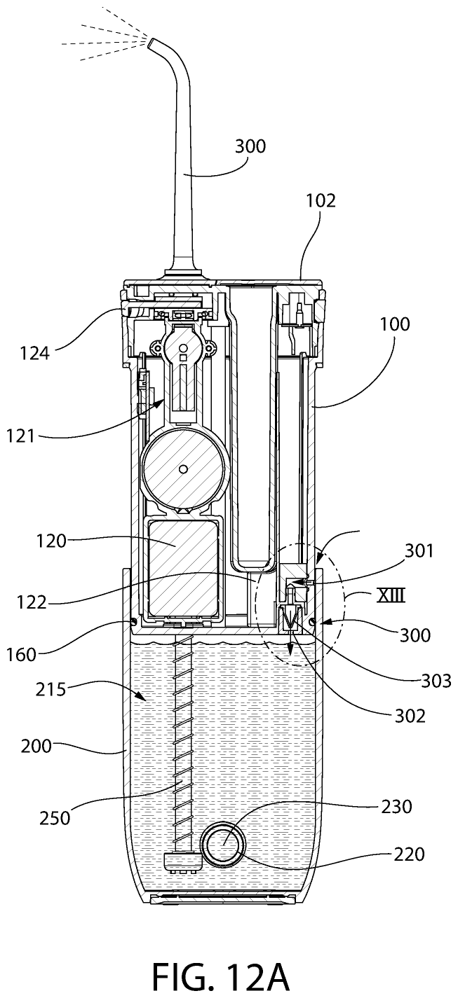

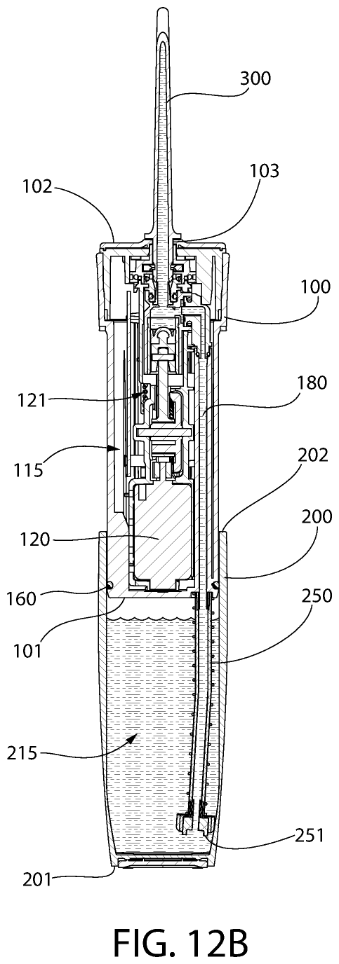

Referring to FIGS. 11, 12A, and 12B, once the switch 124 is actuated, the liquid is pumped from the second cavity 215 and out through the nozzle 300. As noted above, the liquid is pumped by the pump 221 through the delivery member 250 and then through a passageway 180 in the upper housing 200 which is fluidly isolated from the electronic components in the upper housing 200. The liquid flows through the passageway 180 until the liquid is pumped through the outlet 103 in the top end 102 of the upper housing 100 and to and through the nozzle 300. The liquid is sprayed from the nozzle 300 at a desired velocity in order to achieve a desired purpose. For example, when the personal care device 1000 is an oral irrigator or water flosser, the liquid may be sprayed at a velocity sufficient to dislodge particles trapped between the teeth to thereby floss the teeth with the injected liquid. If the personal care device 1000 is a nasal irrigator, the liquid may be injected at a lower velocity. Moreover, the personal care device 1000 may be configured to operate at multiple modes that inject the liquid therefrom at differing velocities which may be selected by a user.

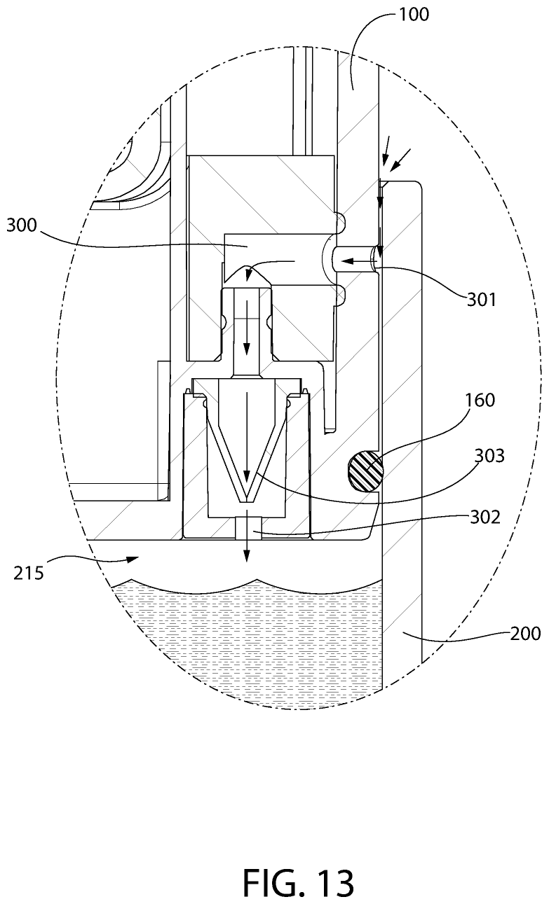

Referring to FIGS. 12A and 13, as the liquid is being pumped from the second cavity 215 of the lower housing 200 to and through the nozzle 300, air is being pulled into the second cavity 215 from ambient in order to prevent a vacuum from forming in the second cavity 215. Thus, as the liquid is pumped from the second cavity 215, air will be pulled through the inlet opening 301 and into the air flow passageway 300, past the one-way valve 303, and out through the outlet opening 302 and into the second cavity 215. A volume of air pulled into the second cavity 215 will be substantially the same as the volume of liquid being removed from the second cavity 215 in order to prevent formation of a vacuum in the second cavity 215. Thus, the air flow passageway 300 is configured to introduce air from the ambient environment (which is the air around and surrounding the personal care device 1000) into the second cavity 215 of the lower housing 200 as the liquid in the second cavity 215 is removed from the second cavity 215.

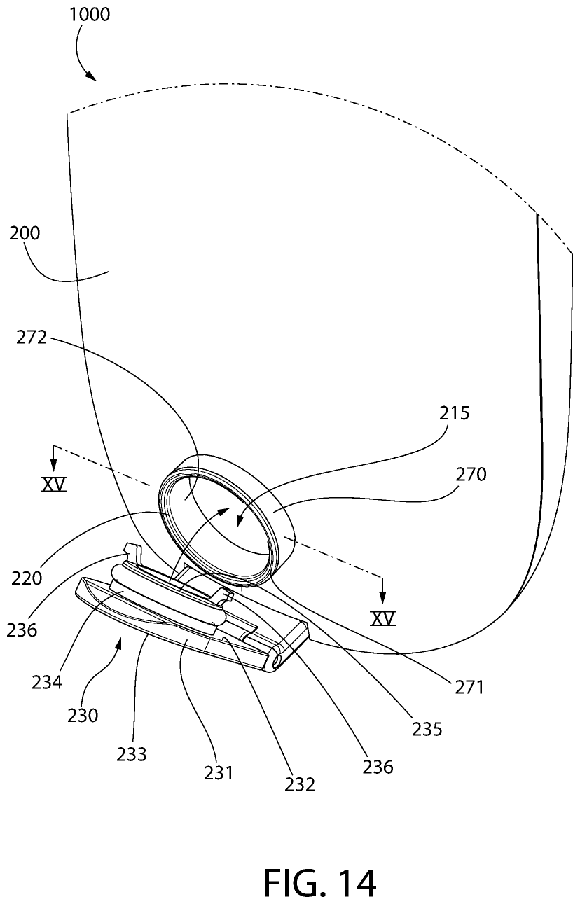

Referring now to FIGS. 14-17, another feature of the personal care device 1000 will be described. This additional feature has to do with the cap 230 and the opening 220 previously described. As noted, the cap 230 is configured to close the opening 220 once liquid is introduced into the second cavity 215 through the opening 220. Thus, it is important that the cap 230 adequately seal the opening 220 to prevent the liquid from leaking out of the second cavity 215 through the opening 220.

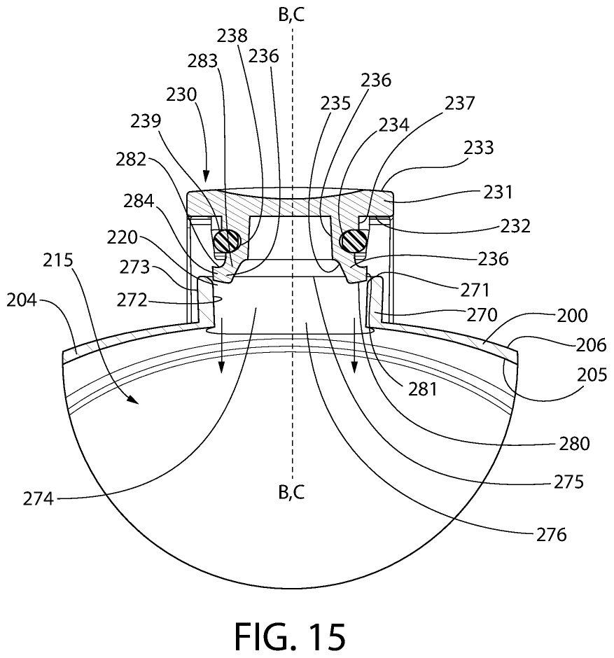

Referring first to FIGS. 14 and 15, the cap 230 comprises a body portion 231 having an inner surface 232 and an outer surface 233, an annular sidewall 234 extending from the inner surface 232 of the body portion 231 to a distal end 235, and a plurality of locking tabs 236 protruding from the distal end 235 of the annular sidewall 234 in a spaced apart manner. The annular sidewall 234 comprises an inner surface 236 and an outer surface 237. Furthermore, there is a groove 238 formed into the outer surface 237 of the annular sidewall 234 and a seal member 239 disposed within the groove 238. When the cap 230 is in the closed state as shown in FIG. 17, the seal member 239 abuts against the outer surface 237 of the annular sidewall 234 and a portion of the lower housing 200 to be described below to form a fluid-tight seal between the cap 230 and the lower housing 200. The seal member 239 may be formed from rubber or various plastics and may be a gasket, an O-ring, or similar type structure. Thus, the cap 230 and the seal member 239 adequately prevent the liquid from leaking out through the opening 220 when the cap 230 is in the closed state. However, in some instances the compression of the seal member 239 between the housing 200 and the cap 230 may not sufficiently hold or lock the cap 230 in the closed state. Specifically, the cap 230 may too easily become altered from the closed state to the open state, or too easily move even slightly away from the closed state, which can allow for leaks. Thus, the locking tabs 236 help to create a lock between the cap 230 and the housing 200 that can only be overcome when a user forcefully pulls the cap 230 away from the housing 200.

In the exemplified embodiment, the locking tabs 236 extend obliquely from the distal end 235 of the annular sidewall 234 of the cap 230. Stated another way, the cap 230 extends along an axis C-C from the distal end 235 of the annular sidewall 234 to the outer surface 233 of the body portion 231. The locking tabs 236 extend from the annular sidewall 234 in a direction away from the axis C-C. The locking tabs 236 comprise a bottom surface 280 and an outer surface 281. The locking tabs 236 also comprise a locking surface 282 that faces upwardly towards the body portion 231. The locking surface 282 is configured to engage the inner surface 205 of the lower housing 200 to lock the cap 230 in the closed state. The term lock does not mean a permanent lock, but instead means that the cap 230 will be held in place and will not move until a force is applied by a user onto the cap 230 to separate the cap 230 from the lower housing 200. Thus, the lock prevents the cap 230 from being detached on its own or accidentally. For example, a user bumping into the cap 230 will not be sufficient to dislodge the cap 230 from the lower housing 200, but rather intentional forceful interaction with the cap 230 is required to remove the cap 230 from the lower housing 200.

The cap 230 is preferably an integrally formed monolithic structure such that the body portion 231, the annular sidewall 234, and the locking tabs 236 are part of the integral component. The cap 230 may be formed from plastic or rubber in various different embodiments. The seal member 239 is a separate component that is affixed around the cap 230 as noted above and shown in the drawings. In the exemplified embodiment, there are two of the locking tabs 236 and they are spaced apart 180° about the circumference of the annular sidewall 234. However, there could be just a single locking tab 236 in some embodiments, or more than two of the locking tabs 236 in other embodiments. The locking tabs 236 are flexible relative to the annular sidewall 234 such that the locking tabs 236 can be flexed inwardly towards the axis C-C or outwardly away from the axis C-C upon application of a force thereon. The cap 230 has a width measured at the locking tabs 236, and more specifically the width is measured along the outer surface 281 of the locking tabs 236.

In the exemplified embodiment, the locking tabs 236 comprise a first portion 283 which extends from the distal end 235 of the annular sidewall 234 and a second portion 284 that extends from the first portion 283. The first portion 283 extends downwardly and outwardly at an angle from the distal end 235 of the annular sidewall 234 and the second portion 284 extends outwardly from the end of the first portion 283.

In the exemplified embodiment, the lower housing 200 comprises an upstanding annular wall 270 that defines the opening 220 into the second cavity 215. The upstanding annular wall 270 protrudes from the outer surface 206 of the lower housing 200 and terminates at a distal end 271. The upstanding annular wall 270 comprises an inner surface 272 and an outer surface 273 opposite the inner surface 272. The inner surface 272 of the upstanding annular wall 270 defines and/or surrounds a passageway 274 that extends along an axis B-B. The passageway 274 extends from a first opening 275 located in alignment with the distal end 271 of the upstanding annular wall 270 to a second opening 276 that is at the intersection of the passageway 274 and the second cavity 215 of the lower housing 200. The width (or transverse cross-sectional area) of the passageway 274 continuously increases moving from the second opening 276 to the first opening 275 (or moving in a direction from the second cavity 215 towards the distal end 271 of the upstanding annular wall 270). That is, the inner surface 272 of the upstanding annular wall 270 diverges with distance from the axis B-B with increasing distance from the outer surface 206 of the lower housing 200 to the distal end 271 of the upstanding annular wall 270. Thus, the passageway 274 has the greatest width (or transverse cross-sectional area) at the distal end 271 of the upstanding annular wall 270.

In the exemplified embodiment, the width of the cap 230 taken along the outer surface 281 of the locking tabs 236 is less than the width of the passageway 274 taken at the first opening 275 which is aligned with the distal edges 271 of the upstanding annular wall 270. As a result, and as shown in FIG. 15, the cap 230 can be inserted into the passageway 274 without any interference or contact between the cap 230 and the upstanding annular wall 270. This is important because it simplifies operation by not requiring a user to pinch the locking tabs 236 to flex inwardly before inserting the cap 230 into the passageway 274.

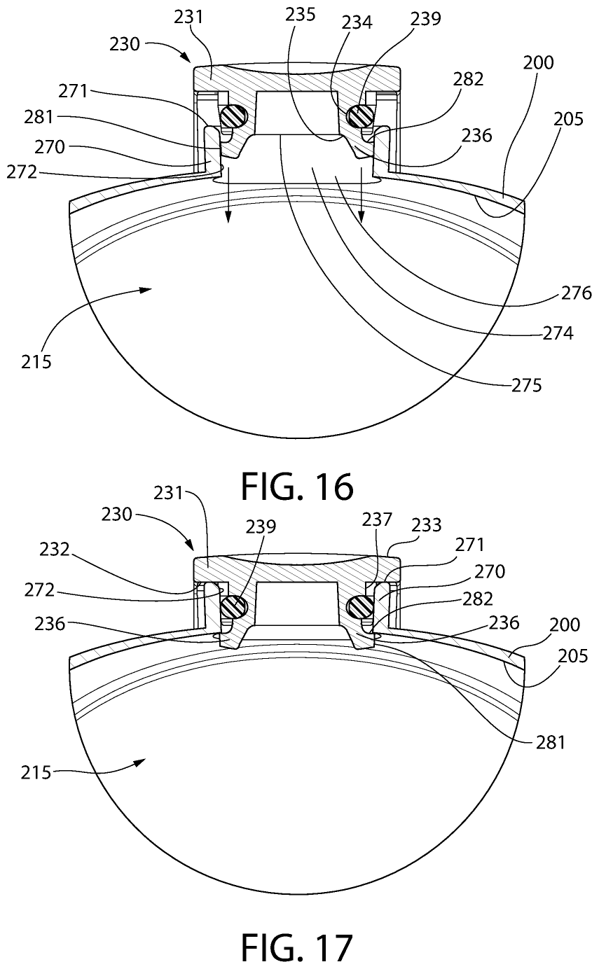

Referring to FIG. 16, as the cap 230 continues to be pressed into the passageway 274 of the upstanding annular wall 270, the inner surface 272 of the upstanding annular wall 270 contacts the outer surface of the locking tabs 236 and presses/flexes them inwardly towards the axes B-B, C-C. This occurs because the width or cross-sectional area of the passageway 274 decreases the closer the passageway 274 is to the second cavity 215 of the lower housing 200. Thus, while the cap 230 can enter the passageway 274 without any contact between the upstanding annular wall 270 and the locking tabs 236, as the cap 230 is moved further into the passageway 274 towards the second cavity 215 the inner surface 272 of the upstanding annular wall 270 will contact the locking tabs 236 and cause them to flex inwardly.

As shown in FIG. 17, once the cap 230 is fully coupled to the lower housing 200, portions of the locking tabs 236 are positioned below the upstanding annular wall 270 and are inside of the second cavity 215. As the portions of the locking tabs 236 exit the passageway 274 and enter the second cavity 215, the locking tabs 236 will flex back outwardly to their natural, unbiased state. In their natural, unbiased state, the width of the cap 230 taken at the outer surface 281 of the locking tabs 236 is greater than the width of the passageway 274 at the second opening 276. As such, portions of the locking tabs 236 extend beyond the passageway 274 and are not in alignment with the passageway 274. That is, the locking surfaces 282 of the locking tabs 236 abut against and engage the inner surface 205 of the second housing 200 at a location that is just outside of the passageway 274. This creates the lock between the cap 230 and the lower housing 200 which requires user force to dislodge and separate the cap 230 from the lower housing 200.

When the cap 230 is fully coupled to the lower housing 200, the inner surface 232 of the body portion 231 of the cap 230 faces and abuts against the distal end 271 of the upstanding annular wall 270. Furthermore, and as noted above, the seal member 239 is compressed between the inner surface 272 of the upstanding annular wall 270 and the outer surface 237 of the annular sidewall 230 of the cap 230. This collectively seals the passageway 274 so that any liquid in the second cavity 215 of the lower housing 200 cannot leak out of the cavity 215 through the passageway 274 and the opening 220 when the cap 230 is in the closed state as shown in FIG. 17. Moreover, and as noted above, the locking surfaces 282 of the locking tabs 236 engage the inner surface 205 of the lower housing 200 to retain the cap in the closed state.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A personal care device comprising:
an upper housing comprising a top end, an outer surface, and a first cavity;
a motor and a pump operably coupled together and located within the first cavity of the upper housing;
a lower housing comprising a second cavity having an open top end, an opening through which liquid can be introduced into the second cavity, and a cap alterable between a closed state whereby the cap closes the opening and an open state whereby the opening forms a passageway from an ambient environment into the second cavity, wherein at least a portion of the upper housing nests within the second cavity of the lower housing and the lower housing is slidably coupled to the upper housing between a compressed position and an expanded position;
an air flow passageway extending from the outer surface of the upper housing to the second cavity of the lower housing; and
wherein upon introducing a liquid into the second cavity through the opening and actuating the motor, the pump is configured to pump the liquid from the second cavity through an outlet in the top end of the upper housing, and wherein as the liquid is pumped from the second cavity air from the ambient environment is introduced into the second cavity through the air flow passageway.

2. The personal care device according to claim 1, further comprising a power source located in the first cavity and operably coupled to the motor and a switch alterable between an off state whereby power is not supplied from the power source to the motor and an on state whereby power is supplied from the power source to the motor to actuate the motor.

3. The personal care device according to claim 1 further comprising a nozzle detachably coupled to the outlet in the top end of the upper housing for dispensing the liquid into an oral cavity.

4. The personal care device according to claim 1 wherein the upper housing extends from a bottom end to a top end along a longitudinal axis, the upper housing comprising a lower axial portion, a middle axial portion, and an upper axial portion, wherein in the compressed position the lower and middle axial portions of the upper housing are positioned within the second cavity of the second housing and the upper axial portion of the upper housing protrudes from the open top end of the second cavity, and wherein in the expanded position the lower axial portion of the upper housing is positioned within the second cavity of the lower housing and the middle and upper axial portions of the upper housing protrude from the open top end of the second cavity.

5. The personal care device according to claim 4 wherein the upper housing comprises a sidewall and a floor that collectively define the first cavity, and wherein the air flow passageway comprises an inlet opening in the sidewall positioned along the lower axial portion of the upper housing and an outlet opening in one of: (1) the sidewall, at a location between the first opening and the floor; and (2) the floor.

6. The personal care device according to claim 5 further comprising a one-way valve disposed within the air flow passageway, the one-way valve allowing the air to flow in a first direction from the inlet opening to the outlet opening and preventing the air from flowing in a second direction from the outlet opening to the inlet opening.

7. The personal care device according to claim 1 wherein the air flow passageway extends from an inlet opening through which the air from the ambient environment enters into the air inlet passageway to an outlet opening through which the air flows from the air flow passageway into the second cavity of the lower housing, and wherein the inlet opening is located along a lower axial portion of the upper housing that is always located within the second cavity of the second housing.

8. The personal care device according to claim 7 wherein the upper housing extends from a bottom end to the top end along a longitudinal axis, and further comprising a seal member positioned around the outer surface of the upper housing at a location between the inlet opening of the air flow passageway and the bottom end of the upper housing, the seal member forming a seal between the outer surface of the upper housing and an inner surface of the lower housing.

9. The personal care device according to claim 8 wherein the inner surface of the lower housing and the outer surface of the upper housing are spaced apart by a gap from the inlet opening of the air flow passageway to a top end of the lower housing.

10. The personal care device according to claim 1 wherein the upper housing comprises a longitudinal axis, and wherein the air flow passageway comprises a first portion that extends in a direction transverse to the longitudinal axis and a second portion that extends in a direction parallel to the longitudinal axis, the first portion comprising an inlet opening of the air inlet passageway and the second portion comprising an outlet opening of the air inlet passageway.

11. The personal care device according to claim 1 wherein the upper housing comprises a floor and a sidewall, and wherein the air flow passageway comprises an inlet opening in the sidewall and an outlet opening in the floor.

12. The personal care device according to claim 1 wherein a volume of the second cavity increases as the lower housing is moved from the compressed position to the expanded position, and further comprising a delivery member coupled to the upper housing by a spring that moves the delivery member deeper into the second cavity as the lower housing moves from the compressed position to the expanded position.

13. The personal care device according to claim 1 wherein the cap comprises:
a body portion having an inner surface;
an annular sidewall extending from the inner surface of the body portion to a distal end; and
at least one locking tabs protruding obliquely from the distal end of the annular sidewall in a spaced apart manner, the at least one locking tabs comprising a locking surface that faces the body portion; and
wherein when the cap is in the closed state, the inner surface of the body portion closes the opening of the housing and the locking surfaces of the at least one locking tab engages an inner surface of the lower housing to retain the cap in the closed state.

14. A personal care device comprising:
an upper housing comprising a sidewall and a floor that define a first cavity;
a nozzle coupled to the upper housing;
a motor and a pump operably coupled together and located within the first cavity of the upper housing;
a lower housing slidably coupled to the upper housing between a compressed position and an expanded position, the lower housing comprising a second cavity having a volume that increases as the lower housing is moved from the compressed position to the expanded position, the second cavity configured to hold a liquid that is configured to be injected by the nozzle upon actuation of the motor; and
an air flow passageway extending from an inlet opening in the sidewall of the upper housing to an outlet opening in the floor of the upper housing, the air flow passageway configured to introduce air from an ambient environment into the second cavity of the lower housing as the liquid in the second cavity of the lower housing is pumped from the second cavity to the nozzle.

15. The personal care device according to claim 14 wherein the upper housing extends from a bottom end to a top end along a longitudinal axis, the upper housing comprising a lower axial portion that is disposed within the second cavity when the lower housing is in the compressed position and the expanded position, a middle axial portion that is disposed within the second cavity when the lower housing is in the compressed position and that protrudes from a top end of the lower housing when the lower housing is in the expanded position, and an upper axial portion that protrudes from the top end of the lower housing when the lower housing is in the compressed position and when the lower housing is in the expanded position, and wherein the air flow passageway is located entirely along the lower axial portion of the upper housing.

16. The personal care device according to claim 15 further comprising a seal member disposed around an outer surface of the upper housing at a location between the inlet opening of the air flow passageway and the bottom end of the upper housing.

17. The personal care device according to claim 16 wherein a gap exists between the outer surface of the upper housing and the inner surface of the lower housing, the gap extending from the inlet opening to the top end of the lower housing so that the air from the ambient environment can flow into the gap prior to entering the air flow passageway.

18. A personal care device comprising:
an upper housing comprising a first cavity;
a motor and a pump positioned in the first cavity and operably coupled together;
a lower housing comprising a second cavity configured to hold a liquid, wherein the lower housing is slidably coupled to the upper housing with a portion of the upper housing positioned within the second cavity; and
an air flow passageway configured to introduce air from an ambient environment into the second cavity of the lower housing as the liquid in the second cavity of the lower housing is pumped from the second cavity through an outlet in the upper housing.

19. The personal care device according to claim 18 wherein the air flow passageway comprises an inlet opening in a sidewall of the upper housing, an outlet opening in a floor of the upper housing, and a one-way valve positioned between the inlet and outlet openings.

20. The personal care device according to claim 18 wherein the lower housing is slidably coupled to the upper housing between an expanded position and a compressed position, a volume of the second cavity being greater in the expanded position than in the compressed position, and wherein the air flow passageway is located along a portion of the upper housing that is surrounded by the lower housing in both of the expanded and compressed positions.

21-35. (canceled)
